(19) United States
(12) Patent Application Publication
(10) Pub. No.: US 2006/0213855 A1
(43) Pub. Date: Sep. 28, 2006

(54) Baby bottle with enlarged lower portion

(76) Inventors: Stephanie Kraus, Glendale, CA (US); Randal Ouye, La Crescenta, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/091,971

(22) Filed: Mar. 28, 2005

(51) Int. Cl. A61J 11/00; A61J 9/08; A61J 9/00

(52) U.S. Cl. 215/11.1; 215/11.6

(57) ABSTRACT

A baby bottle has an essentially pear side wall profile shape. There is a truncated end to the essentially pear side wall profile shape. A projecting ridge portion is located towards the top of the truncated end of the essentially pear side wall profile shape for facilitating holding of the bottle. There is a rim at the top of the side wall for receiving a nipple locating closure. In another format the baby bottle has an elongated side wall. A bottom portion of the wall is of a diameter greater than the diameter towards the top of the bottle. The bottle is formed such the relatively largest diameter portion of the side wall is located about one third from the bottom portion of the bottle. The center of gravity of the bottle is below the midpoint of the longitudinal length.

### RELATED APPLICATIONS

This application is related to U.S. Utility Patent Application filed on Mar. 28, 2005, entitled “MULTI-COMPARTMENT DISPENSING CONTAINER” (Docket No. 54317-040701, Express Mail Label No. EV 310 127 888 US); U.S. Utility Patent Application filed on Mar. 28, 2005, entitled “CLEANING UTENSIL FOR A FLUID CONTAINER” (Docket No. 54317-040702, Express Mail Label No. EV 310 127 891 US); U.S. Utility Patent Application filed on Mar. 28, 2005, entitled “IRREGULAR SHAPED BABY BOTTLE” (Docket No. 54317-040703, Express Mail Label No. EV 310 128 905 US); and U.S. Utility Patent Application filed on Mar. 28, 2005, entitled “A HANDLED DRINKING CONTAINER” (Docket No. 54317-040704, Express Mail Label No. EV 310 127 914 US); all of which have been filed concurrently herewith. The contents of those applications are incorporated by reference herein.

### BACKGROUND

1. Field

This disclosure relates to baby bottle constructions. More particularly the disclosure relates to an ergonomically designed baby bottle.

2. General Background

There are numerous baby bottles on the market, with different functions and features. None of the known bottles provide the features of the present disclosure. The prior art is replete with varying baby bottle sizes and constructions. However, none of the bottles appear to address needs that arise to collectively facilitate balance, handling, and ease of feeding infants.

While the prior art constructions may be adequate for the basic purpose and function for which they have been designed, they fail to provide a simple, efficient, and practical feeding bottle. In particular, the prior art fails to disclose a bottle sized and constructed to enhance an infant's grasp of the bottle and comfort while gripping the bottle.

There is a need for an improved ergonomically designed baby bottle construction that simplifies feeding, and the support functions associated with this.

It is an object of the present disclosure to provide a baby bottle to facilitate drinking, and at the same time making feeding an easier function for the feeding person.

### SUMMARY

A baby bottle has an essentially pear side wall profile shape. There is a truncated end to the essentially pear side wall profile shape. A projecting ridge portion is located towards the top of the truncated end of the essentially pear side wall profile shape for facilitating holding of the bottle. There is a rim at the top of the side wall for receiving a nipple locating closure.

In some cases, the bottom of the bottle is flat and interfaces with the upstanding side wall of the bottle.

In another form, the baby bottle has an elongated curved side wall, and the top of the side wall is for receiving a nipple locating closure. A bottom portion of the wall has a diameter greater than the diameter towards the top of the bottle, and there can be a convex curvature. The bottle is formed such that the relatively largest diameter portion of the side wall is located about one third from the bottom portion of the bottle. The topmost quarter of the side wall can be relatively straight or have a relatively concave curvature. Generally, the wall shape curvatures from the bottom to the top blend harmoniously in a gentle transition.

A projecting ridge portion is relatively closer towards the top than the bottom of the bottle. The projecting ridge portion extends circumferentially in a circle about the wall. The ridge is located substantially in the area of the narrow diameter, and extends circumferentially about the wall in a relatively transverse sense.

### DRAWINGS

The above-mentioned features and objects of the present disclosure will become more apparent with reference to the following description taken in conjunction with the accompanying drawings, wherein like reference numerals denote like elements, and in which:

FIG. 1 is a perspective view of the bottle with the cover removed.

FIG. 2 is a top view of the bottle.

FIG. 3 is a side view of the bottle.

FIG. 4 is a partial side view of the interlock between the rim and the nipple locating closure.

FIG. 5 is a partial side view of the interlock between the rim and the nipple locating closure in an alternate configuration.

### DETAILED DESCRIPTION

The device is now described with reference to an example which is not to be considered as limiting. This is purely an illustration of the device.

One of ordinary skill in the art will understand that the present discussion is a description of exemplary embodiments only, and is not intended as limiting the broader aspects of the present disclosure, which broader aspects are embodied in the exemplary construction. A repeat use of reference characters in the present specification and drawings represents the same or analogous features or elements of the disclosure.

A baby bottle has an essentially pear side wall profile shape. There is a truncated end to the essentially pear side wall profile shape. A projecting ridge portion is located towards the top of the truncated end of the essentially pear side wall profile shape for facilitating holding of the bottle. There is a rim at the top of the side wall for receiving a nipple locating closure. In one form, the bottom of the bottle is flat and interfaces with the side wall of the bottle.

The projecting ridge portion is relatively closer towards the top than the bottom of the bottle and extends circumferentially in a transverse circle about the wall. The projecting ridge portion extends from the relatively straight longitudinal portion of the wall. The ridge is located substantially in the area of the narrow diameter of the bottle.

The wall can be formed by at least two portions or areas. One portion or area is essentially transparent and the other portion or area is essentially opaque. There is a line of distinction between the two portions that is sinuously curved circumferentially around the wall in a circular transverse sense at a location between the truncated top and the bottom of the container.

A cover is provided for the nipple locating closure. The cover is removable, curved and selectively snaps into a location inside or with the ridge at the truncated end.

The nipple locating closure can have a central portion with an aperture for receiving a removable nipple. The peripheral zone has a transparent portion for a window permitting viewing of the interior of the bottle when located on the top of the bottle.

In another format the baby bottle has an elongated side wall, and the top of the side wall receives a nipple locating closure. A bottom portion of the wall is of a diameter greater than the diameter towards the top of the bottle. The bottle is formed such that the relatively largest diameter portion of the side wall is located about one third from the bottom portion of the bottle.

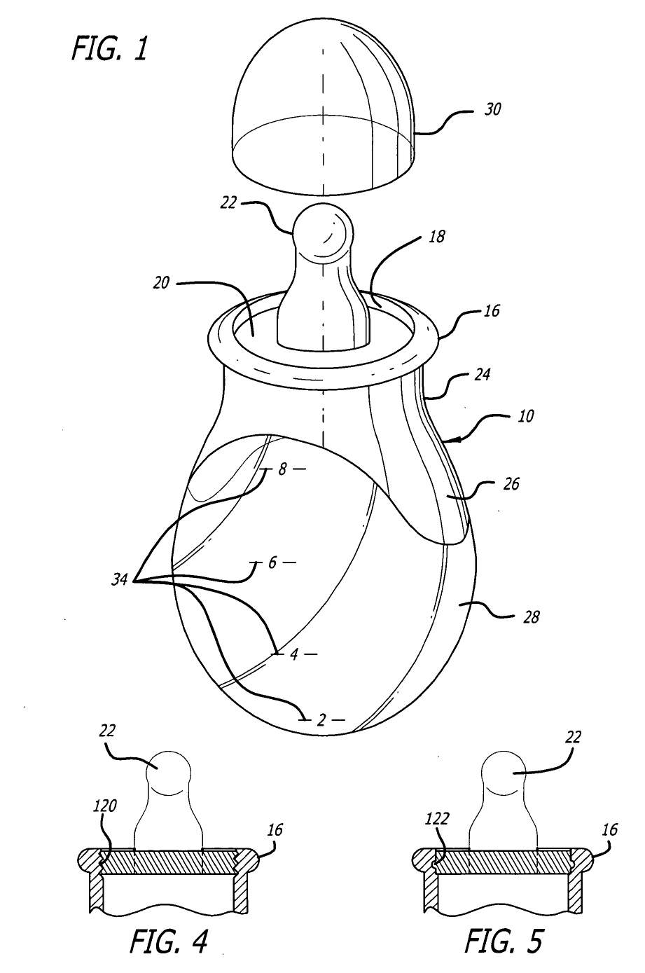

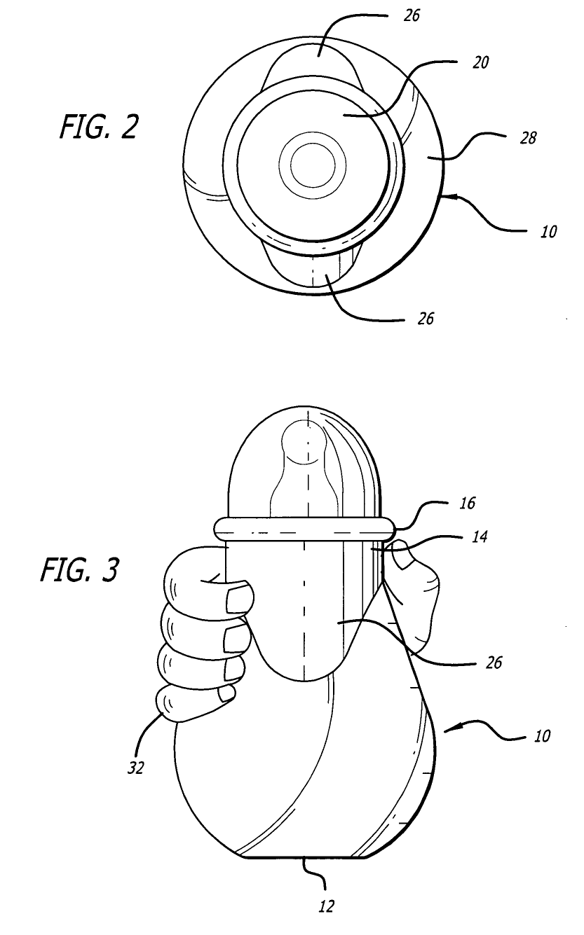

In FIG. 1, there is the perspective view of a pear-shaped baby bottle generally indicated as 10. As can be seen in the side profile of FIG. 3, the pear-shaped bottle 10 has a flat base 12 and a truncated end 14. There is a projecting ridge 16 which is located towards the top 14 for facilitating holding of the bottle. On the inside of the ridge 16, there is a rim 18 for receiving a nipple locating closure 20. The nipple 22 is formed centrally in the closure 20, and is shaped to essentially mimic a human breast nipple and is flexible in response to sucking. The ridge 16 extends circumferentially about the wall 24 which constitutes the bottle, and as can be seen, is at the narrow diameter location of the bottle. The nipple locating closure 20 can clip or screw thread into position with the rim 18 to effect an effective seal. This thread or clip engagement is an internal thread 120 or clip 122 mechanism for engaging the top of the bottle 10 and closure 20.

The wall 24 is formed of two sections 26, one of which is an opaque section and one of which is a substantially transparent portion 28. The portion 28 is below the substantially opaque portion 26. The opaque portion can be of a material to enhance to gripping by the fingers and/or hand generally. Above the nipple 22, there is a substantially hemispherically formed cover 30 which can clip 120 or thread 122 inside the rim 18 so as to hygienically protect the nipple 22. The inter-engagement is such that leakage does not occur. The curved or domed top or cover 30 provides an aesthetic closure to the baby bottle.

The bottle can be of any particular size, and the shape, which is relatively squat, is of a nature that it is formed to match a baby's hand, which is figuratively illustrated by numeral 32 which represents the fingers of the hand.

Additionally, the bottle is easy to hold by a caregiver, such as a mother. It is easy to clean, easy to fill and is leak-proof in its formation of the inter-engaging component parts.

In some other forms of the disclosure, instead of the two substantially equal in area sections which are substantially opaque and substantially transparent, there can be more or less of either one of such sections. The substantially opaque section 26 extends from the top 14 of the bottle downwardly on two sides and is centrally higher on two opposite sides. In this fashion, the opaque section has a substantially curved or substantially sinuous interface which is advantageous. On the face 28 there can be indicia 34 which indicate the measurement height of the bottle so that the amount of liquid in the bottle can easily measured and visibly assessed.

Different degrees of height relative to width are possible. The bottle has a larger lower portion or cross-section than the upper portion or upper cross-section. In this manner, an enhanced, balanced bottle is obtained. Different angular configurations are possible. The center of gravity of the bottle is below the midpoint of the longitudinal length or height of the bottle. The location of the center of gravity is determined with the nipple closure and nipple in place. Alternatively, it is determined without the closure or nipple in place.

The cylindrical top portion and the body may be molded of a suitable plastic material, which may be blow molded, by extrusion or injection, so that it is a unitary member of uniform wall thickness. A suitable transparent plastic for forming the bottle includes, but is not limited to, polystyrene, polystyrene-acrylonitile, acrylonitile-butadiene-styrene, styrene-maleicanhydride, polycarbonate, polyethylene terephthalate, polyvinylcyclohexane, and blends thereof. The thickness of the wall can be such that it is not generally flexible. The bottle itself is made of a relatively lightweight material.

In another form, there is an elongated side wall having an enlarged diameter in an area towards the base and tapering upwardly towards a narrower diameter. The narrower diameter includes a relatively straight longitudinal portion. There is a rim at the top of the wall for receiving a nipple locating closure. The neck of the bottle around which the hand can hold the bottle is about 60-80% of the diameter of the enlarged lower portion. It is sufficient that the neck can locate a nipple closure element which itself can locate a nipple which generally is sized for the mouth of a baby. Accordingly, it is not a narrow neck such as can be common on a soda bottle which is for receiving a crown cork or a cap closure.

Different degrees of relatively squat appearance of the reusable bottle and components making up the reusable bottle are possible. In other words the pear shape can be relatively broader and shorter, or alternatively relatively broader and longer. Having the bottle with the center of gravity at a lower portion below the midpoint of the height provides for enhanced stability. The reusable bottle and its components can be suitably cleaned by hand, dishwasher or the like, so that repetitive use is possible. The two portions of the wall are relatively solid or distinct portions, meaning that one distinct portion is opaque and the other is transparent. In other cases, there are two substantially distinct different opaque type portions.

While the product and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A baby bottle comprises an essentially pear side wall profile shape, a truncated end to the essentially pear side wall profile shape, a projecting ridge portion towards the top of the truncated end of the essentially pear side wall profile shape for facilitating holding of the bottle, and a rim at the top of the side wall for receiving a nipple locating closure.

2. A baby bottle comprises an essentially pear-shaped elongated wall substantially along its length, a projecting ridge portion towards the top of the essentially pear-shaped side wall profile for facilitating holding of the bottle, and a rim at the top of the wall for receiving a nipple locating closure, and wherein the bottom of the bottle is flat and interfaces with the side wall of the bottle.

3. The baby bottle of claim 2, wherein the projecting ridge portion is relatively closer towards the top than the bottom of the bottle.

4. The baby bottle of claim 1, wherein the wall is formed by at least two portions, one portion being essentially transparent and the other portion being essentially opaque.

5. A baby bottle comprises an essentially pear-shaped elongated wall substantially along its length, a projecting ridge portion in the essentially pear-shaped side wall profile for facilitating holding of the bottle, and a rim at the top of the wall for receiving a nipple locating closure.

6. The baby bottle of claim 1, wherein the wall is formed by at least two portions, one portion being the bottom being a first opaque area and including at least essentially transparent windows, and the other portion being the portion above the bottom being an essentially second opaque area.

7. The baby bottle of claim 2, wherein the wall is formed by at least two portions, one portion being the bottom including at least essentially transparent windows and the other portion being the portion above the bottom being essentially opaque, and wherein a line of distinction between the two portions is sinuously curved circumferentially around the wall at a location between the truncated top and the bottom.

8. The baby bottle of claim 1, including a cover for the nipple locating closure, the cover being removable, and wherein the cover is curved and selectively snaps into a location inside the ridge at the truncated end.

9. The baby bottle of claim 2, wherein the projecting ridge portion extends circumferentially in a circle about the outside of the wall.

10. A baby bottle comprises an elongated side wall, a top of the side wall being for receiving a nipple locating closure, and a bottom portion of the wall being of a diameter greater than the diameter towards the top of the bottle, the bottle being formed such the relatively largest diameter portion of the side wall is located about one third from the bottom portion of the bottle.

11. The baby bottle of claim 10, including a projecting ridge portion from the side wall, the projecting ridge portion being relatively closer towards the top than the bottom of the bottle.

12. A baby bottle, the bottle being for reuse, the bottle comprising an elongated side wall, the side wall having an enlarged diameter in an area towards the base and tapering upwardly towards a narrower diameter, the narrower diameter including a relatively straight longitudinal portion towards the top, a rim at the top of the wall for receiving a nipple locating closure, a nipple locating closure, and nipple in the closure, the components being reusable.

13. The baby bottle of claim 12, including a nipple locating closure, the closure having a central portion with an aperture for receiving a removable nipple, a peripheral zone with a transparent portion for a window permitting viewing of the interior of the bottle when located on the top of the bottle.

14. The baby bottle of claim 12, including a projecting ridge portion extending from the relatively straight longitudinal portion of the wall for facilitating holding of the bottle, the ridge being located substantially in the area of the narrow diameter, and the projecting ridge portion extending circumferentially about the wall in a relatively transverse sense.

15. A baby bottle comprises an elongated side wall, the side wall having an enlarged cross-section in an area towards the base and a narrow cross-section towards the top, a rim at the top of the wall for receiving a nipple locating closure, the center of gravity of the bottle being located below the midpoint of the bottle, and the diameter at the top being about 60% to 80% of the diameter of the enlarged cross-section.

16. The baby bottle of claim 15, wherein the projecting ridge portion is relatively closer towards the top than the bottom of the bottle.

17. The baby bottle of claim 15, wherein the wall is formed by solely two portions, one portion being essentially transparent and the other portion being essentially opaque.

18. The baby bottle of claim 15, wherein the wall is formed by at least two portions, one portion being the bottom being a first opaque area and including at least essentially transparent windows, and the other portion being the portion above the bottom being an essentially second opaque area.

19. The baby bottle of claim 15, including a cover for the nipple locating closure, the cover being removable, and wherein the cover is curved and selectively snaps or is threaded into a location inside the ridge at the truncated end.

20. The baby bottle of claim 15, wherein the projecting ridge portion extends circumferentially in a circle about the wall, and including the nipple locating closure and a nipple in the closure, the components being the bottle, closure and nipple, being of a material permitting reuse after cleaning.
